(19) United States
(12) Patent Application Publication
(10) Pub. No.: US 2018/0341608 A1
(43) Pub. Date: Nov. 29, 2018

(54) COMMUNICATION DEVICE

(71) Applicant: DENSO CORPORATION, Kariya-city (JP)

(72) Inventor: Toshiaki Iwasaki, Kariya-city (JP)

(21) Appl. No.: 15/980,860

(22) Filed: May 16, 2018

(30) Foreign Application Priority Data
May 25, 2017 (JP) 2017-103605

(51) Int. Cl. G06F 13/40; G06F 13/36

(52) U.S. Cl. CPC G06F 13/409; G06F 13/36

(57) ABSTRACT

A first communication device and a second communication device are used in a communication system among which a communication signal is exchanged via a single bus, and include a driver circuit that drives the bus according to driver drive signals and a slope setter setting a slope to the communication signal. In both communication devices, (i) a drive of the bus by the driver circuit is validated (a) in a first period having the driver drive signals at a first level that instructs dominant and (b) in a second period, which is a slope period from a level change of the driver drive signals changing from the first level to a second level that instructs recessive until an end of a time delay corresponding to a slope, and (ii) the drive of the bus by the driver circuit is invalidated in periods other than the first and second periods.

### CROSS REFERENCE TO RELATED APPLICATION

The present application is based on and claims the benefit of priority of Japanese Patent Application No. 2017-103605, filed on May 25, 2017, the disclosure of which is incorporated herein by reference.

### TECHNICAL FIELD

The present disclosure generally relates to a communication device in a communication system, which uses a single communication line to send and receive a communication signal for a communication among a plurality of the communication devices.

### BACKGROUND INFORMATION

The in-vehicle communication in a vehicle may be, for example, implemented by a method such as LIN (Local Interconnect Network), CXPI (Clock Extension Peripheral Interface) or the like. In such communication methods, a plurality of communication devices communicate, i.e., exchange communication signals among them, via a single communication line, or a bus,

The communication devices in the bus communication system described above are equipped with a driver circuit that includes a feedback circuit which feedbacks the bus signal, for providing a slope to a wave form of a bus signal that drives the bus. Such configuration may, however, suffer from an external noise that rides on the bus signal to enter the driver circuit via the feedback circuit, and may cause malfunction of the driver circuit.

For example, patent document 1, Japanese Patent No. 5418208, discloses a noise counter-measure in a communication system, in which a plurality of communication devices are connected to the same communication line for communication and exchange of the communication signals. The technique disclosed in the patent document 1 is that, for a preset period after a detection timing of a dominant-recessive change which is detected based on a received communication signal, a potential of an input line for inputting a potential of the communication line is set to a recessive representing potential in the communication system.

By using the above-described technique, malfunction caused by the influence of a reflection wave that is generated at a timing of a dominant-recessive change is prevented. However, the above-described technique cannot prevent malfunction of the driver circuit caused by the external noise which arrives at an unpredictable timing from outside of the communication device.

### SUMMARY

It is an object of the present disclosure to provide a noise-proof communication device that prevents and/or limits malfunctions caused by external noise.

In an aspect of the present disclosure, a communication device used in a communication system for a transmission of a communication signal among a plurality of the communication devices via a single communication line, includes: a driver circuit, a slope setter, and a driver controller. The driver circuit transmits a communication signal representing dominant by driving the communication line, and transmits a communication signal representing recessive by not driving the communication line, according to a transmission signal. The slope setter sets a slope to the communication signal by providing a feedback of a signal of an output node that is connected to the communication line. The driver controller validates and invalidates a drive of the communication line by the driver circuit in a first period, in a second period and in other period, among which (i) (a) the first period is for validation of the drive of the communication line by the driver circuit, and is a period where the transmission signal is in a first level that instructs dominant, (b) the second period is also for validation of the drive of the communication line by the driver circuit, and is a period from a start timing of a level change of the transmission signal changing from the first level to a second level that instructs recessive to an end timing of a preset time delay corresponding to the slope, and (ii) the other period is a period other than the first and second periods, and is for invalidation of the drive of the communication line by the driver circuit.

In the above-described configuration, from a start of the first period to an end of the second period, the driver circuit should, or is supposed to, transmit a communication signal representing dominant. On the other hand, in other period other than the first and second periods, the driver circuit is not supposed to transmit a communication signal representing dominant. Therefore, the above-described configuration of the communication device enables the driver circuit to drive the communication line in the first and second periods, during which the driver circuit is supposed to transmit a communication signal representing dominant. Further, in other periods, during which the driver circuit is not supposed to transmit a communication signal representing dominant, the driver circuit is not enabled to drive the communication line. Thus, in periods other than the first and second periods, even when the external noise riding on the bus enters the driver circuit, malfunction, i.e., the drive of the communication line erroneously performed by the driver circuit, is limited and/or prevented. That is, the communication device configured in the above-described manner is capable of limiting and/or preventing malfunction due to the external noise.

### BRIEF DESCRIPTION OF THE DRAWINGS

Objects, features, and advantages of the present disclosure will become more apparent from the following detailed description made with reference to the accompanying drawings, in which:

FIG. 1 is a block diagram of a communication system in a first embodiment of the present disclosure;

FIG. 2 is a block diagram of a driver circuit in the first embodiment of he present disclosure;

FIG. 3 is a block diagram of a feedback circuit in the first embodiment of the present disclosure;

FIG. 4 is a block diagram of an output driver in the first embodiment of the present disclosure;

FIG. 5 is another block diagram of the output driver in the first embodiment of the present disclosure;

FIG. 6 is a time chart of a signal wave form of each part in the first embodiment of the present disclosure;

FIG. 7 is a block diagram of a communication system in a second embodiment of the present disclosure; and

FIG. 8 is a time chart of a signal wave form of each part in the second embodiment of the present disclosure.

### DETAILED DESCRIPTION

Hereafter, embodiments of the present disclosure are described with reference to the drawing. In each of the following embodiments, the same numerals are assigned to the same configuration/component, and description of the same configuration/component is not repeated.

### First Embodiment

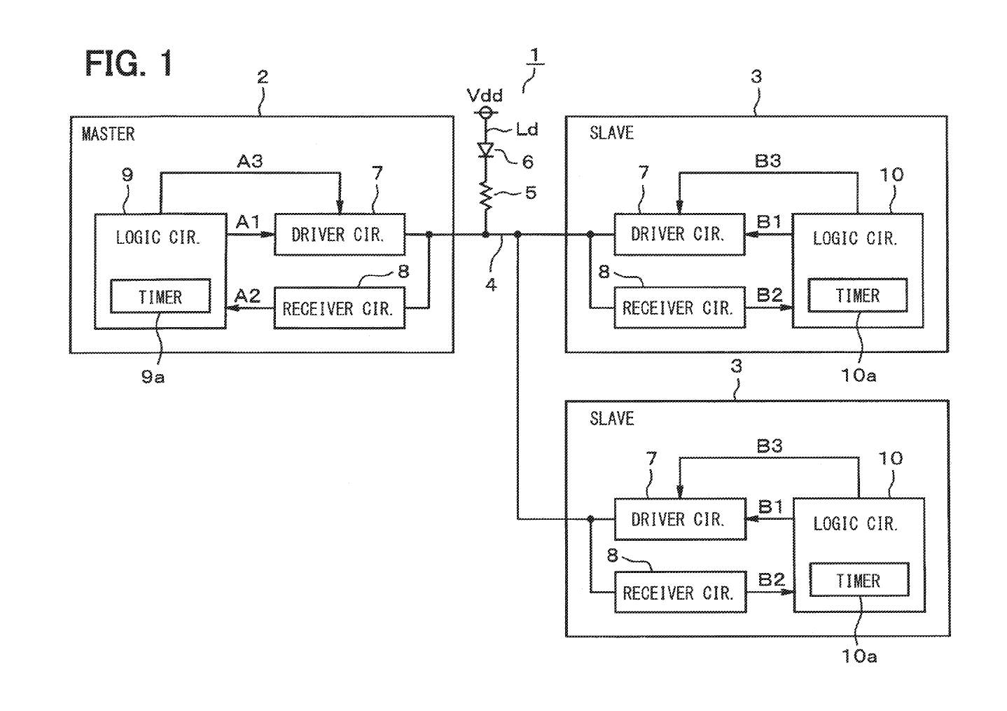

Hereafter, the first embodiment of the present disclosure is described with reference to FIGS. 1-6.

A communication system 1 shown in FIG. 1 is used for the control communication between two or more electrical control units disposed, for example, in a vehicle. The communication system 1 has a configuration in which a master communication device 2 and plural slave communication devices 3 are connected via a bus 4, i.e., a single communication line. The communication devices 2 and 3 are respectively constituted, for example, as an ASIC (Application Specific Integrated Circuit). The bus 4, corresponding to a communication line, is connected to a power supply line Ld for supplying electric power having a power supply voltage Vdd via a pull-up resistor 5 and a reversely-put diode 6.

The master communication device 2 is provided with a driver circuit 7, a receiver circuit 8, and a logic circuit 9. A driver drive signal A1 and a driver OFF signal A3 respectively output from the logic circuit 9 are given to the driver circuit 7. The driver drive signal A1 corresponds to a transmission signal, and the level of the signal A1 changes, i.e., switches, between the high level (for example, 5V) which instructs dominant and the low level (for example, 0V) which instructs recessive. Note that the high level corresponds to a first level, and the low level corresponds to a second level, in the present embodiment. In the following description, the low level may also be designated as L level, and the high level may also be designated as H level.

The driver circuit 7 transmits a communication signal representing dominant by driving the bus 4 according to the driver drive signal A1. The driver circuit 7 transmits a communication signal representing recessive by not driving the bus 4. That is, when the driver drive signal A1 changes to L level, the driver circuit 7 starts to drive the bus 4, and, when the driver drive signal A1 changes to H level, the driver circuit 7 stops or suspends the drive of the bus 4.

The driver circuit 7 is configured to switch, i.e., to validate and invalidate, its drive operation, according to the level of the driver OFF signal A3. That is, when the driver OFF signal A3 is at L level, the driver circuit 7 is in a bus-drivable state where the bus 4 can be driven by the driver circuit 7, and, when the driver OFF signal A3 is at H level, the driver circuit 7 is in a non-drivable state where the bus 4 cannot be driven by the driver circuit 7.

The receiver circuit 8 receives an input of a signal from the bus 4, and outputs a reception signal A2 according to the received signal to the logic circuit 9. The logic circuit 9 generates the driver drive signal A1 based on the data for transmission, and outputs the signal A1 to the driver circuit 7. Further, the logic circuit 9 receives an input of the reception signal A2 from the receiver circuit 8, and performs required processing based on an input of the reception signal A2.

The logic circuit 9 validates or invalidates, by generating the driver OFF signal A3 and outputting the signal A3 to the driver circuit 7, the drive of the bus 4 by the driver circuit 7. More practically, the logic circuit 9 validates the drive of the bus 4 by putting the driver OFF signal A3 at L level in a first period in which the driver drive signal A1 is at H level and in a second period from an H to L level change of the driver OFF signal A3 to an end of a preset time delay. Further, the logic circuit 9 invalidates the drive of the bus 4 by putting the driver OFF signal A3 at H level in other period other than the first and second periods. Thus, the logic circuit 9 validates or invalidates the drive of the bus 4 by the driver circuit 7, thereby corresponds to a driver controller.

The above-mentioned time delay is a time corresponding to a slope given to the communication signal, and, more practically, is set to a time, which may correspond to a required amount of time for a change of a potential of the bus 4, i.e., for the changing from a potential at L level of dominant to a potential at H level of recessive. The logic circuit 9 is provided with a timer 9a, and measures, by using the timer 9a, the amount of time delay, i.e., from an H to L level change timing of the driver drive signal A1 to an end timing of the time delay.

The slave communication device 3 is provided with the driver circuit 7, the receiver circuit 8, and the logic circuit 10. In this case, a driver drive signal B1 and a driver OFF signal B3 respectively output from the logic circuit 10 are given to the driver circuit 7. The driver drive signal B1 corresponds to a transmission signal, and is the same/similar signal as the driver drive signal A1. The driver circuit 7 drives the bus 4 according to the driver drive signal B1, just like the driver circuit 7 of a master device drives the bus 4. The driver circuit 7 is configured to switch, i.e., to validate and invalidate, its drive operation, according to the level of the driver OFF signal B3.

The receiver circuit 8 receives an input of the signal from the bus 4, and outputs a reception signal B2 to the logic circuit 10 according to the received signal. The logic circuit 10 generates the driver drive signal B1 based on the data for transmission, and outputs the signal B1 to the driver circuit 7. Further, the logic circuit 10 receives an input of the reception signal B2 from the receiver circuit 8, and performs required processing based on an input of the reception signal B2.

The logic circuit 10 corresponds to a driver controller, just like the logic circuit 9. That is, the logic circuit 10 validates or invalidates, by generating the driver OFF signal B3 and outputting the signal B3 to the driver circuit 7, the drive of the bus 4 by the driver circuit 7. The logic circuit 10 is provided with a timer 10a, and measures, by using the timer 10a, the amount of time delay, i.e., from an H to L level change timing of the driver drive signal B1 to an end timing of the time delay.

In the communication system 1 of the present embodiment, data exchange is performed, i.e., data is transmitted and received, by, for example, CXPI (Clock Extension Peripheral Interface) communication method. In CXPI communication, the master communication device 3 always supplies a clock signal (i.e., a synchronization signal) to the bus 4, and transmits the clock signal to the slave communication device 3. Further, the master communication device 2 and the slave communication device 3 are configured to transmit a data signal by superposing/putting it on the clock signal.

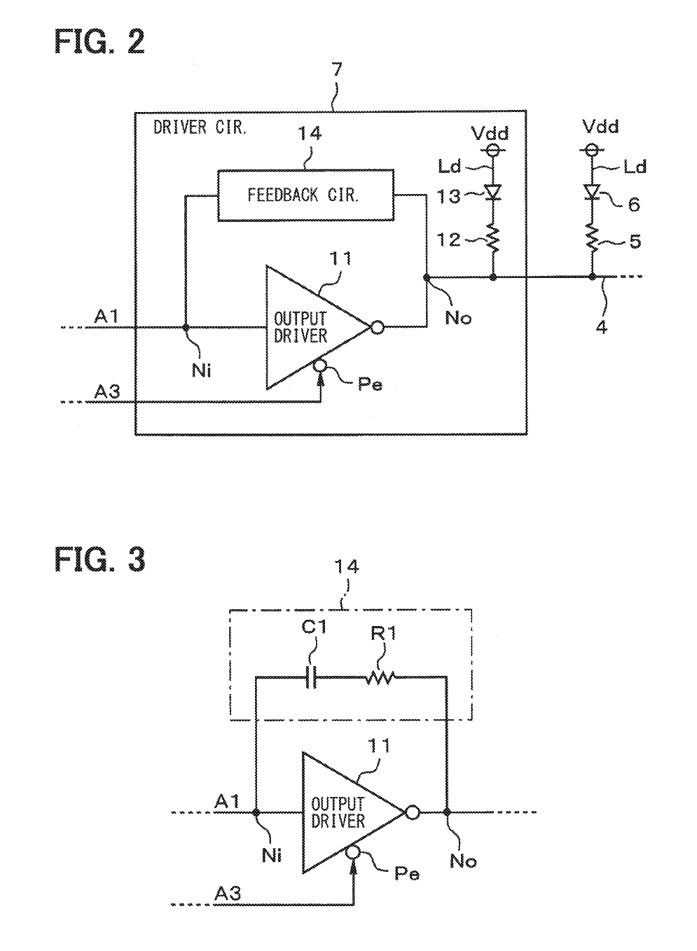

As a concrete configuration of the above-mentioned driver circuit 7, a block diagram in FIG. 2 may serve an example. The block diagram in FIG. 2 illustrates the driver circuit 7 in a master device, which is commonly applicable to the driver circuit 7 in a slave device. As shown in FIG. 2, the driver circuit 7 is provided with an output driver 11, a pull-up resistor 12, a diode 13, and a feedback circuit 14.

The input terminal of the output driver 11 is connected to an input node Ni to which the driver drive signal A1 is given, and the output terminal of the output driver 11 is connected to an output node No connected to the bus 4. The node No is connected to the power supply line Ld for supplying electric power having the power supply voltage Vdd via the resistor 12 and the reversely-put diode 13.

The feedback circuit 14 is connected to a position between the node Ni is and the node No (i.e., to a position between the input terminal and the output terminal of the output driver 11). According to such configuration, the signal of the node No is fed back to the input terminal of the output driver 11, and, as a result, a slope is given to an output signal of the driver circuit 7, and is thus given to a signal of the bus 4, which is the communication signal of the bus 4. Therefore, in the present embodiment, the feedback circuit 14 corresponds to a slope setter.

As concrete configuration of the feedback circuit 14, a block diagram in FIG. 3 may serve an example. As shown in FIG. 3, the feedback circuit 14 is provided with a series circuit of a resistor R1 and a capacitor C1 which are connected to a position between the input terminal and the output terminal of the output driver 11, and is thus connected to a position between the input terminal and the output terminal of the driver circuit 7.

The output driver 11 is a driver having an enable function, and is provided with an enable terminal Pe. The driver OFF signal A3 is given to the enable terminal Pe of the output driver 11. Validation and invalidation of the function are changed according to the level of the signal given to the enable terminal Pe of the output driver 11. More practically, the function of the output driver 11 is validated when the driver OFF signal A3 is in L level, and is invalidated when the driver OFF signal A3 is in H level,

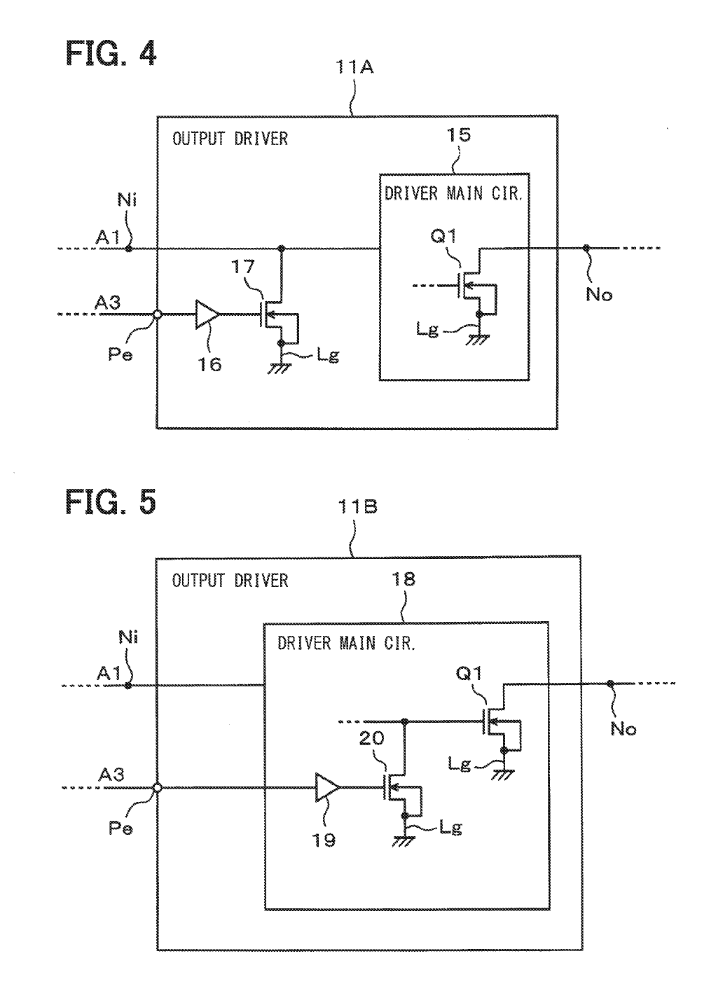

As a concrete configuration of such an output driver 11, a block diagram in FIG. 4 or 5 serve as an example. An output driver 11A shown in FIG. 4 is provided with a driver main circuit 15, a buffer 16, and a transistor 17 which is an N channel type MOS transistor. The driver main circuit 15 has an open drain output configuration, and switches a transistor Q1 in the output stage ON and OFF according to the signal inputted via the input node Ni.

The buffer 16 receives an input of the driver OFF signal A3, and outputs a signal according to the received signal A3. The output of the buffer 16 is given to the gate of the transistor 17. The source of the transistor 17 is connected to a ground line Lg which has a reference potential (=0V) of a circuit, and the drain of the transistor 17 is connected to the input node Ni.

According to such configuration, in a period where the driver OFF signal A3 is at L level, the transistor 17 is switched OFF, thereby the driver main circuit 15 can switch the transistor Q1 ON and OFF according to the driver drive signal A1. That is, the drive of the bus 4 by the output driver 11A, and by the driver circuit 7 ultimately, is validated in a period where the driver OFF signal A3 is at L level.

On the other hand, in a period where the driver OFF signal A3 is at H level, the transistor 17 is switched ON, thereby the input signal to the driver main circuit 15 is fixed, i.e., stays, at L level. Therefore, the transistor Q1 in the output stage of the driver main circuit 15 is fixed to OFF, regardless of the level of the driver drive signal A1. Therefore, in a period where the driver OFF signal A3 is at H level, the drive of the bus 4 by the output driver 11A, and by the driver circuit 7 ultimately, is invalidated.

An output driver 11B shown in FIG. 5 is provided with a driver main circuit 18. Just like the driver main circuit 15 shown in FIG. 4, the driver main circuit 18 has an open drain output configuration, and switches the transistor Q1 in the output stage ON and OFF according to the signal inputted via the input node Ni.

The driver main circuit 18 is provided with a transistor 20 which is an N channel type MOS transistor together with a buffer 19. The buffer 19 receives an input of the driver OFF signal A3, and outputs a signal according to the received signal A3. The output signal of the buffer 19 is given to the gate of the transistor 20. The source of the transistor 20 is connected to the ground line Lg, and the drain of the transistor 20 is connected to the gate of the transistor Q1.

According to such configuration, in a period where the driver OFF signal A3 is at L level, the transistor 20 is switched OFF, thereby the driver main circuit 18 can switch the transistor Q1 ON and OFF according to the driver drive signal A1. That is, the drive of the bus 4 by the output driver 11B, and by the driver circuit 7 ultimately, is validated in a period where the driver OFF signal A3 is at L level.

On the other hand, in a period where the driver OFF signal A3 is at H level, the transistor 20 is switched ON, thereby the transistor Q1 is fixed to OFF regardless of the level of the driver drive signal A1. Therefore, the drive of the bus 4 by the output driver 11B, and by the driver circuit 7 ultimately, is invalidated in a period where the driver OFF signal A3 is at H level.

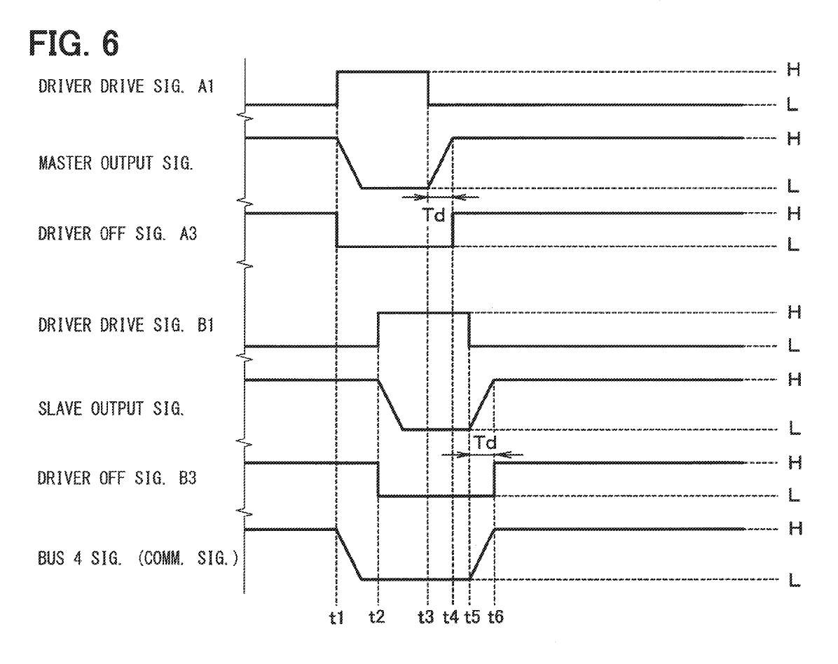

Next, the operation based on the above-mentioned configuration of the communication device is described with reference to FIG. 6.

As shown in FIG. 6, the driver OFF signal A3 on a master side i) falls at time t1 synchronizing with the rise of the driver drive signal A1, and ii) rises at time t4, which is after lapse of a time delay Td from time t3 at which the driver drive signal A1 falls. The time delay Td is an amount of time corresponding to the slope given to the output signal of the driver circuit 7, as mentioned above. More practically, the time delay Td is set to a required time for the output signal of the driver circuit 7 on a master side to change from L level to H level,

In a period where the driver OFF signal A3 is at L level (i.e., a period between time t1 and time t4), the drive of the bus 4 by the driver circuit 7 on a master side is validated. Therefore, in such a period, the driver circuit 7 on a master side can output the communication signal representing dominant by driving the bus 4.

Further, in a period after time t4 in which the level of the output signal of the driver circuit 7 on a master side has changed to H level representing recessive, the drive of the bus 4 by the driver circuit 7 on a master side is invalidated. Therefore, in the period after time t4, even when the external noise from outside rides on, or is coupled to a signal entering the driver circuit 7 (i.e., entering into a feedback loop), the bus 4 will not be driven by the driver circuit 7, and the level of the output signal is maintained at H level representing recessive. Note that, in such case, the period between time t1 and time t3 corresponds to the first period described above, and the period between time t3 and time t4 corresponds to the second period described above.

Further, the driver OFF signal B3 on a slave side i) falls at time t2 synchronizing with the rise of the driver drive signal B1, and ii) rises at time t6, which is after the lapse of the time delay Td from time t5 at which the driver drive signal B1 falls. The time delay Td is, just like the time delay Id on a master side, set to a required time for the output signal of the driver circuit 7 to change from L level to H level.

The drive of the bus 4 by the driver circuit 7 on a slave side is validated in a period when the driver OFF signal B3 is at L level (i.e., in a period between time t2 and time t6). Therefore, in such period, the driver circuit 7 on a slave side can output the communication signal representing dominant by driving the bus 4.

Further, the drive of the bus 4 by the driver circuit 7 on a slave side is invalidated in a period after time t6, where the level of the output signal of the driver circuit 7 on a slave side has changed to H level representing recessive. Therefore, in the period after time t6, even when the external noise from outside rides on a signal to enter the driver circuit 7 (i.e., enter into a feedback loop), the bus 4 will not be driven by the driver circuit 7, and the level of the output signal is maintained at H level representing recessive. Note that, in such case, the period between time t2 and time t5 corresponds to the first period described above, and the period between time t5 and time t6 corresponds to the second period described above.

According to the present embodiment described above, the following effects are achievable.

The driver circuit 7 in the communication devices 2 and 3 of the present embodiment is provided with the feedback circuit 14 for giving a slope to the communication signal transmitted and received via the bus 4. in such configuration, when the external noise rides on the bus 4, such a noise may enter the driver circuit 7 via the feedback circuit 14, and may cause malfunction of the driver circuit 7.

Thus, in the communication devices 2 and 3 of the present embodiment, the drive of the bus 4 by the driver circuit 7 is configured to be validated i) in the first period in which the driver drive signals A1 and B1 are respectively at H level which instruct dominant and ii) in the second period from a level change timing of the driver drive signals A1 and B1 changing from H level to L level which instruct recessive until an end timing of the time delay Td that corresponds to the slope described above. Further, in the communication devices 2 and 3, the drive of the bus 4 by the driver circuit 7 is invalidated in periods other than the first period and the second period.

In the above-mentioned configuration, a period i) from the start of the first period ii) to the end of the second period is a period in which the driver circuit 7 is supposed to transmit the communication signal representing dominant. On the other hand, a period other than the first period and the second period is not a period in which the driver circuit 7 is supposed to transmit the communication signal representing dominant. Therefore, according to the above-mentioned configuration, the driver circuit 7 is enabled to drive the bus 4 in a period in which the driver circuit 7 is supposed to transmit the communication signal representing dominant, and can actually transmit the communication signal representing dominant.

On the other hand, in periods other than the dominant signal transmission period described above, i.e., in a period in which the driver circuit 7 is not supposed to transmit the communication signal representing dominant, the driver circuit 7 is not enabled to drive the bus 4. Therefore, even when, in such a period, the external noise from the outside rides on the bus 4 to enter the driver circuit 7, the bus 4 will not be driven accidentally/erroneously by the driver circuit 7, and the level of communication signal is maintained at H level representing recessive. Thus, according to the present embodiment, the effect of limiting and/or preventing malfunctions that may otherwise be caused by the external noise can be achieved.

The timing of validating the drive of the bus 4 by the driver circuit 7, i.e., the level change timing of the driver OFF signals A3 and B3 changing from H level to L level, may be at least synchronized with a level change timing of the driver drive signals A1 and B1 changing from L level to H level. Further, since each of these signals is generated either by the logic circuit 9 or 10, adjustment of such timing (i.e., synchronization) can be easily performable. Therefore, according to the present embodiment, the drive of the bus 4 by the driver circuit 7 can be validated at a suitable timing.

Further, the timing of invalidating the drive of the bus 4 by the driver circuit 7, i.e., the level change timing of the driver OFF signals A3 and B3 changing from L level to H level may be at least synchronizing with a level change completion timing of the output signal from the driver circuit 7, i.e., with an end timing of level change of the output signal from the driver circuit 7 changing to H level representing recessive. Here, the level change completion timing of the output signal completely changing to H level is after lapse of the time delay Td (i.e., after the slope) from the level change timing of the driver drive signals A1 and B1 changing from H level to L level. The time delay Td by the slope can be predicted in advance based on the specification of a circuit or the like. Thus, in the present embodiment, the logic circuits 9 and 10 are provided with the timers 9a and 10a, and are configured to measure the time delay Td by using the timers 9a and 10a after the level change timing of the driver drive signals A1 and B1 changing from H level to L level. According to such configuration, the drive of the bus 4 by the driver circuit 7 can be invalidated at a suitable timing.

### Second Embodiment

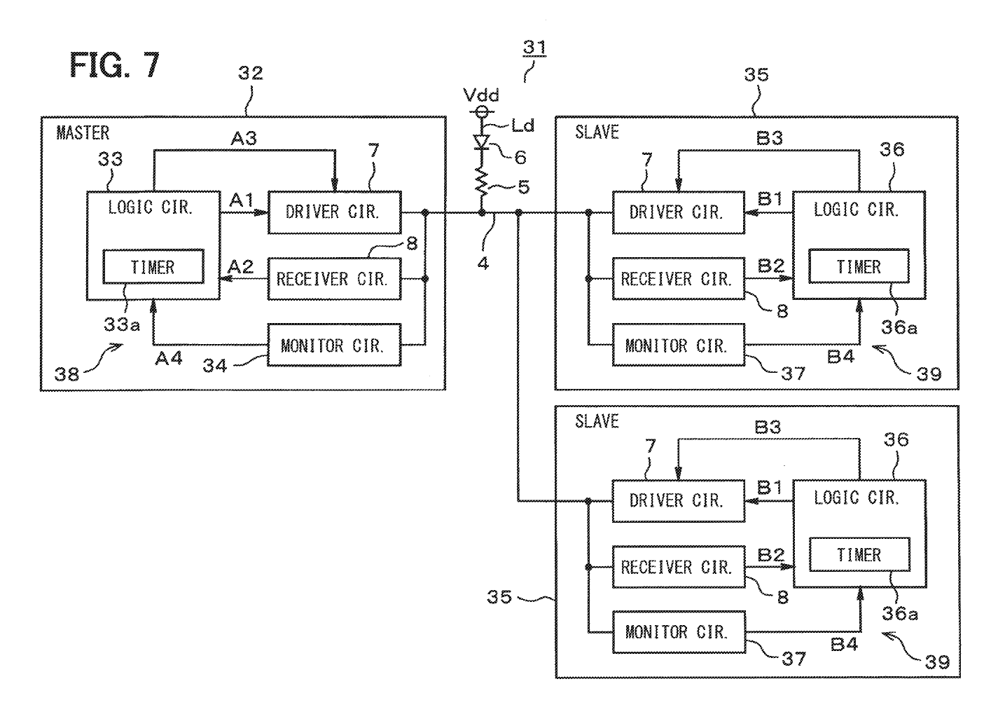

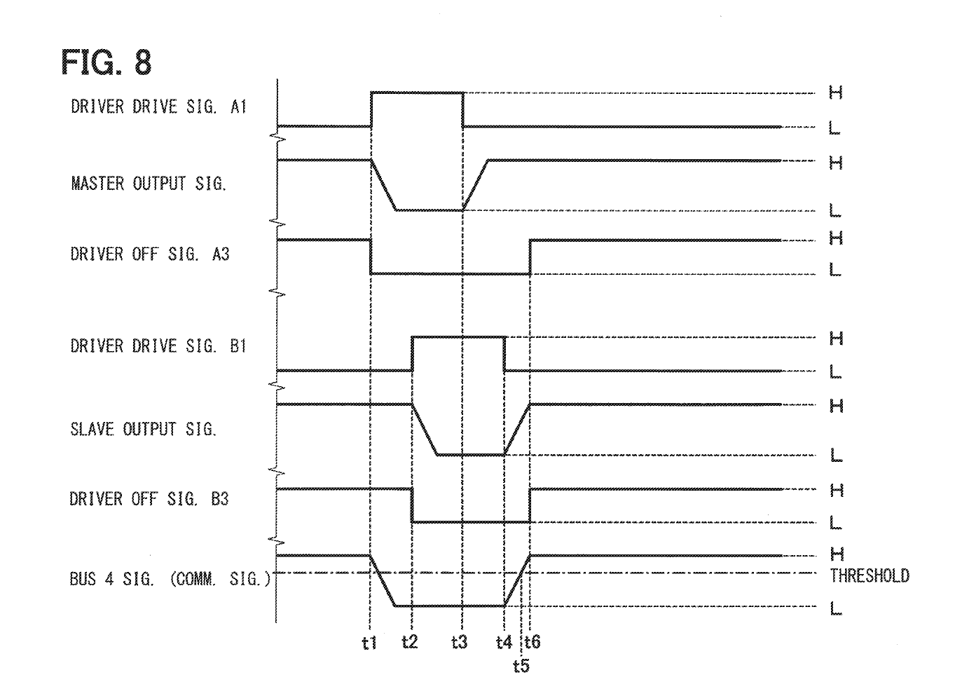

Hereafter, the second embodiment of the present disclosure is described with reference to FIGS. 7 and 8.

As shown in FIG. 7, a master communication device 32 in a communication system 31 of the present embodiment has, instead of having the logic circuit 9 in the communication device 2 of the first embodiment, a logic circuit 33, and is additionally provided with a monitor circuit 34. Those differences from the first embodiment are described in detail below.

The monitor circuit 34 monitors a potential of the bus 4, and when it is detected that the potential of the bus 4 has reached an intermediate potential, the monitor circuit 34 outputs a detection signal A4 at H level to the logic circuit 33. The above-mentioned intermediate potential is an arbitrary potential, somewhere between a potential representing dominant and a potential representing recessive. In the present embodiment, 80% of the potential at H level representing recessive is set as the intermediate potential.

The logic circuit 33 generates the driver drive signal A1 and the driver OFF signal A3 just like the logic circuit 9 does. However, the logic circuit 33 differs from the logic circuit 9 in a generation technique of the driver OFF signal A3. That is, in the logic circuit 33, the fall of the driver OFF signal A3 synchronizes with the level change timing of the driver drive signal A1 changing from L level to H level. Further, in the logic circuit 33, the rise of the driver OFF signal A3 synchronizes with an after-delay timing, which is after the lapse of a time delay from an output timing of a detection signal A4 at H level being output from the monitor circuit 34.

The above-mentioned time delay is a time corresponding to the slope given to the communication signal, and is set to a required amount of time for the potential of the bus 4 to change from the intermediate potential to the potential representing recessive. The logic circuit 33 is provided with a timer 33a, and measures time from a detection timing when the potential of the bus 4 has reached the intermediate potential, which is detected by the monitor circuit 34 by using the timer 33a, until an end of the time delay.

A slave communication device 35 in the communication system 31 of the present embodiment has, instead of having the logic circuit 10 in the communication device 3 of the first embodiment, a logic circuit 36, and is additionally provided with a monitor circuit 37. Those differences from the first embodiment are described in detail below. The monitor circuit 37 has the same configuration as the monitor circuit 34, and, when it is detected that the potential of the bus 4 has reached the intermediate potential, the monitor circuit 37 outputs a detection signal B4 at H level to the logic circuit 36.

The logic circuit 36 generates the driver drive signal 81 and the driver OFF signal B3, just like the logic circuit 10 does. However, the logic circuit 36 is different from the logic circuit 10 in a generation technique of the driver OFF signal B3. That is, in the logic circuit 36, the fall of the driver OFF signal B3 synchronizes with the level change timing of the driver drive signal B1 changing from L level to H level. Further, in the logic circuit 36, the rise of the driver OFF signal B3 synchronizes with an after-delay timing, which is after the lapse of a time delay from an output timing of the detection signal A4 at H level being output from the monitor circuit 34. The logic circuit 36 is provided with a timer 36a, and measures time from a detection timing when the potential of the bus 4 has reached the intermediate potential, which is detected by the monitor circuit 37 by using the timer 36a, until an end of the time delay.

Note that, in the master communication device 32 of the present embodiment, a driver controller 38 is constituted by the logic circuit 33 and the monitor circuit 34. Further, in the slave communication device 35 of the present embodiment, a driver controller 39 is constituted by the logic circuit 36 and the monitor circuit 37.

Next, the operation of the communication device having the above-mentioned configuration is described with reference to FIG. 8.

As shown in FIG. 8, the driver OFF signal A3 on a master side falls at time t1, synchronizing with the rise of the driver drive signal A1, and the signal A3 rises at time t6.

The drive of the bus 4 by the driver circuit 7 on a master side is validated in a period where the driver OFF signal A3 is at L level (i.e., in a period between time t1 and time t6). Therefore, in such a period, the driver circuit 7 on a master side can output the communication signal representing dominant by driving the bus 4.

Further, in a period after time t6, the drive of the bus 4 by the driver circuit 7 on a master side is invalidated. Therefore, in the period after time t6, even when the external noise from outside rides on a signal to enter the driver circuit 7, the bus 4 will not be driven by the driver circuit 7, and the level of the output signal is maintained at H level representing recessive.

Further, the driver OFF signal B3 on a slave side i) falls at time t2 synchronizing with the rise of the driver drive signal B1, and ii) rises at time t6. The drive of the bus 4 by the driver circuit 7 on a slave side is validated in a period where the driver OFF signal B3 is at L level (i.e., in a period between time t2 and time t6). Therefore, in such period, the driver circuit 7 on a slave side can output the communication signal representing dominant by driving the bus 4.

Further, the drive of the bus 4 by the driver circuit 7 on a slave side is invalidated in a period after time t6. Therefore, in the period after time t6, even when the external noise from outside the communication system 31 rides on a signal to enter the driver circuit 7, the bus 4 will not be driven by the driver circuit 7, and the level of the output signal is maintained at H level representing recessive.

As described above, the communication devices 32 and 35 of the present embodiment are devised that, in a period where the communication signal representing dominant is supposed to be transmitted, the driver circuit 7 is enabled to drive the bus 4, and can actually transmit the communication signal representing dominant. Further, in periods other than the dominant signal transmission period described above, the driver circuit 7 is not enabled to drive the bus 4. Therefore, even when, in such a period, the external noise from outside the communication system 31 is transmitted via the bus 4 to enter the driver circuit 7, the bus 4 will not be driven accidentally/erroneously by the driver circuit 7, and the level of the communication signal is maintained at H level representing recessive. Thus, the effect of limiting and/or preventing a malfunction that may otherwise be caused by the external noise is achievable in the present embodiment, just like the first embodiment.

Further, in the present embodiment, the timing of invalidating the drive of the bus 4 by the driver circuit 7, i.e., the level change timing of the driver OFF signals A3 and B3 changing from L level to H level may be at least synchronized with a potential change completion timing of the potential of the bus 4, i.e., an end timing of potential change at which the potential of the bus 4 has completely changed to H level representing recessive. Here, the potential change completion timing completely changing the potential to H level is after the lapse of the time delay, which corresponds to the slope, from an output timing of the detection signals A4 and B4 at H level output from the monitor circuits 34 and 37. The time delay corresponding to the slope can be predicted in advance based on the specification of a circuit, or the like.

Therefore, in the present embodiment, the logic circuits 33 and 35 are provided with the timers 33a and 35a, and are configured to measure a “time delay”, i.e., an interval of two timings, for example from time t5 to t6, from the first timing of when the bus potential has reached the intermediate potential to the second timing of when the delay time ends by using the timers 33a and 35a. According to such configuration, the drive of the bus 4 by the driver circuit 7 can be invalidated at a suitable timing. The time delay in this case is shorter than the time delay in the first embodiment. Therefore, an error in the prediction of the time delay becomes relatively small, thereby the drive of the bus 4 by the driver circuit 7 can be invalidated at a more appropriate timing than the first embodiment.

### Other Embodiments

The present disclosure may be enhanced based on the above description. That is, the above embodiments are not a limiting example of the present disclosure, and, as long as the gist of the present disclosure is included, the embodiments of the present disclosure may further be modified and/or combined with each other.

The present disclosure is not limited only to the communication devices 2, 3, 32, and 35 used in the communication systems 1 and 31 which perform CXPI communication, but may also be applicable to other communication system for performing LIN communication, which transmits and receives the communication signal among the plurality of communication devices via the single communication line.

The concrete configuration of providing a slope to the communication signal may not only be the feedback circuit 14, but may also be the other similar device or component capable of doing the same, which is arbitrarily adoptable.

The concrete configuration of the driver circuit 7 may not be the only configuration employed by each of the above-mentioned embodiments, but may also be a configuration having the same/similar function, which is arbitrarily adoptable.

As for the configuration for validating or invalidating the drive of the bus 4 by the driver circuit 7, it may be modified from the one shown in FIGS. 4 and 5, which is arbitrarily adoptable. For example, separation of the output of the driver circuit 7 from the bus 4 may be adopted as a configuration for invalidating the drive of the bus 4.

Although the present disclosure is described based on the above embodiments, it is understood that the present disclosure is not limited to the above, but includes other modifications and equivalents. In addition, the combination of the different embodiments in part or as a whole, as well as introduction of additional elements and the like may also be considered as constituting the present disclosure.

Although the present disclosure has been fully described in connection with preferred embodiment thereof with reference to the accompanying drawings, it is to be noted that various changes and modifications will become apparent to those skilled in the art, and such changes, modifications, and summarized schemes are to be understood as being within the scope of the present disclosure as defined by appended claims.

What is claimed is:

1. A communication device used in a communication system for a transmission of a communication signal to another communication device via a single communication line, the communication device comprising:
a driver circuit driving or not driving the communication line to transmit the communication signal representing dominant or recessive according to a transmission signal;
a slope setter setting a slope of the communication signal by providing a feedback of a signal of an output node that is connected to the communication line; and
a driver controller validating and invalidating the driving of the communication line by the driver circuit, the driving of the communication line (i) validated (a) in a first period where the transmission signal is at a first level of instructing dominant and (b) in a second period of a preset time delay corresponding to the slope where the transmission signal changes to a second level of instructing recessive at a second period start timing, and stays therein to a second period end timing, and (ii) invalidated in periods other than the first period and the second period.

2. The communication device of claim 1, wherein
the time delay is set to have a duration that corresponds to a required amount of time for a dominant-to-recessive potential change of the communication line which is caused by the drive of the communication line by the driver circuit, and
the driver controller includes a timer measuring a time from (i) a level change timing of the transmission signal changing from the first level to the second level to (ii) an end timing of the preset time delay.

3. The communication device of claim 1, wherein
the time delay is set as a duration that corresponds to a required amount of time for a change of a potential of the communication line, changing from an intermediate potential in between a potential representing dominant and a potential representing recessive to a potential representing recessive, which is caused by the drive of the communication line by the driver circuit, and
the driver controller includes:
a monitor circuit monitoring the potential of the communication line; and
a timer measuring a time from a detection timing of the intermediate potential by the monitor circuit to an end timing of the time delay.

4. The communication device of claim 1, wherein
the slope setter is provided with a series circuit of a resistor and a capacitor disposed at a position between an input terminal and an output terminal of the driver circuit.
